(19) United States
(12) Patent Application Publication
(10) Pub. No.: US 2012/0004389 A1
(43) Pub. Date: Jan. 5, 2012

(54) METHOD FOR EXTRACTING PROPOLIS USING FAR-INFRARED RAYS FROM EARTHENWARE

(76) Inventor: Yong Kwang Lee, Jeollabuk-do (KR)

(21) Appl. No.: 13/257,189

(22) PCT Filed: May 14, 2010
(86) PCT No.: PCT/KR2010/003064

§ 371 Date: Sep. 16, 2011

(30) Foreign Application Priority Data
May 14, 2009 (KR) 10-2009-0042170

(51) Int. Cl. C09F 1/00

(52) U.S. Cl. 530/200

(57) ABSTRACT

A method for extracting propolis by using far infrared ray from pottery. The method for extracting propolis by using far infrared ray from pottery makes it possible to prohibit the growth of microorganism by way of far infrared ray by using pottery which emits far infrared ray and has a construction that inside and outside air can exchange while increasing a storage and seasoning effect. Aldehyde contained in alcohol is naturally radiated with the help of air circulation and preventing oxidation decay and shortening an extraction period of propolis.

### TECHNICAL FIELD

The present invention relates to a method for extracting propolis by using far infrared ray from pottery, and in particular to a method for extracting propolis by using far infrared ray from pottery which makes it possible to prohibit the growth of microorganism by means of far infrared ray by using pottery which emits far infrared ray and has a construction that inside and outside air can exchange while increasing a storage and seasoning performance and naturally radiating aldehyde contained in alcohol with the help of air circulation and preventing oxidation decay and shortening an extraction period of propolis.

### BACKGROUND ART

Propolis is generally made as a result that bee mixes a resin extracted from plants with her saliva and enzyme for her survival and growth. The Propolis contains 270 kinds of substances of which organic materials and minerals (inorganic materials) are most contained. Among the contained substances, mineral, vitamins, amino acid, fat, organic acid and flavonoids play key roles in cell metabolism, and terpene plays a function of anticancer. In particular, it contains more than 100 kinds of flavonoids which enhance health.

A number of methods are being developed so as to extract beneficial components from propolis. The extracting method consists of an alcohol extraction method, a water-based extraction method, a micelles extraction method, an ultra-critical extraction method, etc.

Among the above extraction methods, the alcohol extraction method is most widely used because a lot of effective components can be extracted from propolis.

Since the alcohol extraction needs more than six months for a seasoning process by means of which a lot of time and work are needed. In the conventional art, a metallic pottery or a synthetic resin pottery is generally used for a seasoning process which results in an oxidation in propolis or a degradation in quality by means of violet ray.

Since air circulation is not properly performed for a seasoning process in the conventional alcohol extraction method, aldehyde is produced by means of insufficient oxidation of alcohol.

Far infrared ray is a long wavelength infrared ray, which is generally produced from a pottery made of clay.

According to CIE (International Commission on Illumination), it is defined that the wavelength of far infrared ray is in a range of 3.0 um-1000 um, and it is generally defined that a commercial wavelength of far infrared ray is in a range of 2.5 um-30 um which corresponds to 4 eV-0.5 eV without causing any chemical reaction.

As a method for storing foods, a number of researches are being conducted. Among such methods, some methods are focusing on using specific enzyme or chemical. In recent years, a study is being conducted on a method for extending the period that the quality of foods starts changing with the help of the principle of excellent far infrared ray radiation which has excellent penetration ability into the foods.

In addition, according to a result of studies, far infrared ray is known to significantly enhance storage and seasoning effect of foods.

### DISCLOSURE OF INVENTION

Accordingly, it is an object of the present invention to provide a method for extracting propolis by using far infrared ray from pottery which makes it possible to prohibit the growth of microorganism by means of far infrared ray by using pottery which emits far infrared ray and has a construction that inside and outside air can exchange while increasing a storage and seasoning effect and naturally radiating aldehyde contained in alcohol with the help of air circulation and preventing oxidation decay and shortening an extraction period of propolis from six months in the conventional art to three months. As a result, it is possible to produce a quality propolis and significantly enhance productivity.

To achieve the above objects, there is provided a method for extracting propolis by using far infrared rays from pottery which comprises a mixing step for mixing propolis source lump and an alcohol mixture containing alcohol; a first seasoning step for inputting the mixture of the propolis source lump and the alcohol mixture mixed in the mixing step into a porous first pottery which is made of clay and emits far infrared rays and repeatedly performing seasoning and agitations; and a second seasoning step for purifying the mixture in the first pottery processed in the first seasoning step and moving the same to a second pottery coated with natural enamel and repeatedly performing seasoning and agitations.

In the method for extracting propolis by using far infrared rays from pottery, the propolis source lump in the mixing step is a solidified propolis source lump.

In the method for extracting propolis by using far infrared rays from pottery, there are further provided a solidification step for solidifying propolis source lump by storing the same at 1° C.-10° C. for three days; and a grinding step for finely grinding the propolis source lump solidified in the solidification step.

In the method for extracting propolis by using far infrared rays from pottery, the mixing step is directed to mixing at a ratio of 1:1 the propolis source lump finely ground in the grinding process with a quality alcohol mixture containing 60 weight %-80 weight % of alcohol.

In the method for extracting propolis by using far infrared rays from pottery, in the first seasoning step, the first pottery is stored in a first extraction chamber which maintains 10° C.-38° C. and is repeatedly seasoned and agitated therein, and in said second seasoning step, the second pottery is stored in a second extraction chamber which maintains 10° C.-20° C. and is repeatedly seasoned and agitated therein.

In the method for extracting propolis by using far infrared rays from pottery, the first extraction chamber in the first seasoning step maintains 30° C.-38° C. during the day and maintains 10° C.-15° C. at night, and the period of the first seasoning step is one month, and the period of the second seasoning step is two months.

In the method for extracting propolis by using far infrared rays from pottery, in the first seasoning step, the mixture is agitated once every three days.

In the method for extracting propolis by using far infrared rays from pottery, the first and second extraction chambers of the first and second seasoning steps are made of red clay, respectively.

### ADVANTAGEOUS EFFECTS

The method for extracting propolis by using far infrared ray from pottery according to the present invention makes it possible to significantly enhance the productivity by shortening a seasoning period of propolis, which is a very rare material since it is generally collected by a very small amount, from six months in the conventional art to three months. The method also makes it possible to prohibit the growth of microorganism by means of far infrared ray by using pottery which emits far infrared ray and has a construction that inside and outside air can exchange while increasing storage and seasoning effect and naturally radiating aldehyde contained in alcohol with the help of air circulation. A quality propolis can be produced by preventing oxidation decay.

### BRIEF DESCRIPTION OF THE DRAWINGS

The present invention will become better understood with reference to the accompanying drawings which are given only by way of illustration and thus are not limitative of the present invention, wherein;

FIG. 1 is a flow chart of a method for extracting propolis by using far infrared ray from pottery according to the present invention.

### BEST MODE FOR CARRYING OUT THE INVENTION

The preferred embodiments of the present invention will be described with reference to the accompanying drawings.

First of all, the method for extracting propolis by using far infrared ray from pottery according to the present invention will be described.

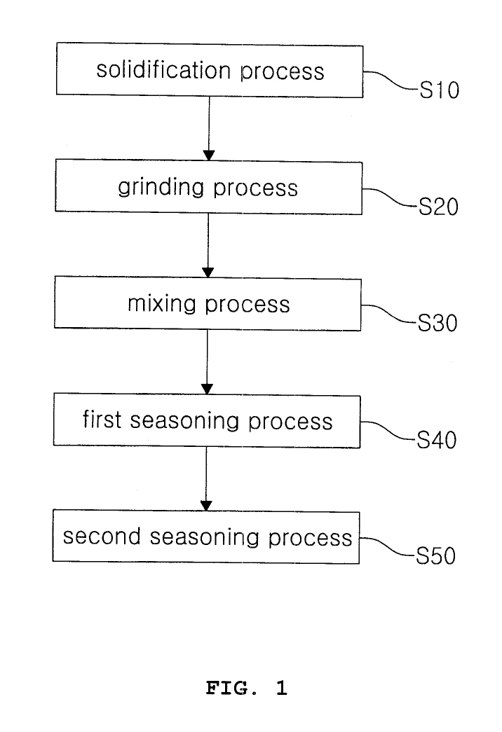

FIG. 1 is a flow chart of a method for extracting propolis by using far infrared ray from pottery according to the present invention.

As shown in the drawings, the method for extracting propolis by using far infrared ray from pottery according to an embodiment of the present invention comprises a solidification process S10, a grinding process S20, a mixing process S30, a first seasoning process S40 and a second seasoning process S50.

The solidification process S10 is directed to solidify a propolis source lump for making grinding easier before the grinding process S20.

The propolis source lump generally becomes solid below 15° C. and is smooth and flexible and has high viscosity at 25° C.-45° C. and becomes solution at above 60° C. and changes its property at above 100° C.

In the solidification process S10, the propolis source lump is stored for three day at 1° C.-10° C., namely, for 72 hours based on the characteristics of the temperature of the propolis source lump for thereby solidifying the same.

The grinding process S20 is directed to grinding the solidified propolis source lump which was solidified through the solidification process S10.

In the grinding process S20, the propolis source lump is finely ground for mixing it uniformly before the mixing process S30.

The mixing process S30 is directed to mixing at a ratio of 1:1 the propolis source lump finely ground in the grinding process S20 with a quality alcohol mixture containing 60 weight %-80 weight % of alcohol.

In the mixing process S30, it is directed to using the alcohol extraction method among many propolis extraction methods.

It is preferred that the mixing process S30 is directly performed in a first pottery which will be described later. Namely, the propolis source lump finely ground is inputted into the first pottery until the alcohol mixture becomes a weight % of 1:1, and the mixture is well agitated so that the propolis source lump and the alcohol mixture are uniformly mixed.

In the first seasoning process S40, the propolis source lump and the alcohol mixture mixed in the mixing process S30 are inputted into the porous first pottery which is made of clay and emits far infrared ray, and the first pottery is seasoned in a first extraction chamber for one month which maintains a temperature of 30° C.-38° C. during the day and maintains at a temperature of 10° C.-15° C. at night, and the mixture in the first pottery is agitated once every three days.

The first pottery consists of a pottery lid and a pottery body, and the above mixture is inputted into the pottery body and is stored with the pottery lid covered, and the above procedures are performed in the same manner as for a second pottery.

The first pottery is made of clay, so a lot of far infrared ray are emitted. As described in the background art, the growth of microorganism is prohibited in propolis with the help of far infrared ray, and the storing performance and seasoning effects can be enhanced.

As for the effects by means of the far infrared ray in the pottery, when far infrared ray is applied to the foods stored in a Chinese ware, the coupling forces of moisture contained in the foods are strengthened, and the number of free molecular of water decreases for thereby prohibiting the growth of microorganism. According to a report from Japan, it says that far infrared rays prohibit an enzyme operation in foods and enhance the storing performance and seasoning effects of foods. In recent years, it is possible to prohibit the growth of microorganism by coating ceramic on a far infrared ray lamp and emitting on foods while prohibiting the enzyme operation in foods for thereby enhancing the storing performance and seasoning effects of foods. The above technology is actually being applied to the industry.

As a result of the experiment which was conducted in Korea by inputting Kimchi into a common Chinese ware which is made by adding red clay, it says that a freshness can be maintained longer with the help of delayed production of lactic acid. In addition, it is reported that the speed of vitamin C decomposition can be decreased, and the seasoning effect can be delayed.

The first pottery made of clay has a number of pores in its wall with the help of sand or bigger particles contained in the clay since enamel is not coated in the first pottery as compared to the second pottery. So, heat insulation is performed by means of the pores, so air circulates inside and outside the first pottery.

In the present invention, it is possible to prevent an oxidation problem and quality degradation due to violet ray which is generally caused in a conventional art because potter is made of a metallic material or a synthetic resin material used for a seasoning process. In addition, it is possible to prevent an oxidation decay of propolis extract since oxygen is supplied into the interior of the first pottery.

Since the pores of the first pottery do not have any glass phases, the inner and outer sides of the pottery communicate through capillary tubes, so heat insulation effect is obtained, and a desired air circulation effect is obtained due to an efficient air circulation. A proper amount of oxygen is supplied, which results in preventing oxidation decay. The pottery is known to discharge wastes from the inner side to the outside of the ware, which can be proven by a phenomenon that white salt components can be seen on the outer surfaces of the pottery filled with soy sauce or soybean paste.

In addition, it is possible to prevent aldehyde, which is generally produced due to insufficient oxidation of alcohol and is a big problem in the conventional art, from producing by circulating air in the first pottery. Even when a small amount of aldehyde is produced, it can be discharged to the outside.

The first extraction chamber is designed to maintain 30° C.-38° C. during the day and to maintain 10° C.-15° C. at night and is made of red clay.

Namely, the first extraction chamber is made in a red clay structure, and the first pottery is stored in the interior of the first extraction chamber for thereby preventing oxidation problems which might occur due to a sealed structure by maintaining a proper temperature and moisture good for extracting propolis based on the characteristics of red clays. Since violet rays can be basically prevented, a quality propolis can be extracted with the help of red clay.

With the constructions of the first pottery and the first extraction chamber, the first seasoning process S40 can be completed within one month, and when the mixture was agitated once every three days, it was possible to extract a quality propolis.

In the second seasoning process S50, the mixture in the first pottery processed in the first seasoning process S40 is purified and moved to the second pottery coated with enamel is stored in the second extraction chamber for two months, which maintains 10° C.-20° C., and the seasoning and agitation processes are repeatedly performed.

Since the second pottery used in the second seasoning process S50 is moved after the mixture of the first pottery processed in the first seasoning process S40 is purified, the second pottery is coated by natural enamel as compared to the first pottery used in the first seasoning process S40 for thereby obtaining less air circulation as compared to the first pottery.

The second extraction chamber is designed to maintain 10° C.-20° C. and is made of red clay like the first extraction chamber. The second extraction chamber is made of red clay for the reasons described in the first extraction chamber.

When the second pottery and the second extraction chamber are used in the present invention, the second seasoning process S50 took only two months.

As for the seasoning period for extracting propolis according to the present invention, the first seasoning process S40 and the second seasoning process S50 took three months which means that the total period can be reduced by half as compared to the conventional alcohol extraction method which needs six months, which results in enhancing productivity. Since the seasoning process is performed by using far infrared rays from the pottery, it is possible to extract a quality propolis.

### INDUSTRIAL APPLICABILITY

In the method for extracting propolis by using far infrared ray from pottery according to the present invention, it is possible to prohibit the growth of microorganism by means of far infrared ray by using pottery which emits far infrared ray and has a construction that inside and outside air can exchange while increasing a storage and seasoning effect and naturally radiating aldehyde contained in alcohol with the help of air circulation and preventing oxidation decay and shortening an extraction period of propolis.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A method for extracting propolis by using far infrared rays from pottery, comprising:
a mixing step for mixing propolis source lump and an alcohol mixture containing alcohol;
a first seasoning step for inputting the mixture of the propolis source lump and the alcohol mixture mixed in the mixing step into a porous first pottery which is made of clay and emits far infrared rays and repeatedly performing seasoning and agitations; and
a second seasoning step for purifying the mixture in the first pottery processed in the first seasoning step and moving the same to a second pottery coated with natural enamel and repeatedly performing seasoning and agitations.

2. The method of claim 1, wherein said propolis source lump in the mixing step is a solidified propolis source lump.

3. The method of claim 2, further comprising:
a solidification step for solidifying propolis source lump by storing the same at 1° C.-10° C. for three days; and
a grinding step for finely grinding the propolis source lump solidified in the solidification step.

4. The method of claim 3, wherein said mixing step is directed to mixing at a ratio of 1:1 the propolis source lump finely ground in the grinding step with a quality alcohol mixture containing 60 weight %-80 weight % of alcohol.

5. The method of claim 1, wherein in said first seasoning step, the first pottery is stored in a first extraction chamber which maintains 10° C.-38° C. and is repeatedly seasoned and agitated therein, and in said second seasoning step, the second pottery is stored in a second extraction chamber which maintains 10° C.-20° C. and is repeatedly seasoned and agitated therein.

6. The method of claim 5, wherein said first extraction chamber in the first seasoning step maintains 30° C.-38° C. during the day and maintains 10° C.-15° C. at night, and the period of the first seasoning step is one month, and the period of the second seasoning step is two months.

7. The method of claim 5, wherein in said first seasoning step, the mixture is agitated once every three days.

8. The method of claim 5, wherein said first and second extraction chambers of the first and second seasoning steps are made of red clay, respectively.

9. The method of claim 2, wherein in said first seasoning step, the first pottery is stored in a first extraction chamber which maintains 10° C.-38° C. and is repeatedly seasoned and agitated therein, and in said second seasoning step, the second pottery is stored in a second extraction chamber which maintains 10° C.-20° C. and is repeatedly seasoned and agitated therein.

10. The method of claim 3, wherein in said first seasoning step, the first pottery is stored in a first extraction chamber which maintains 10° C.-38° C. and is repeatedly seasoned and agitated therein, and in said second seasoning step, the second pottery is stored in a second extraction chamber which maintains 10° C.-20° C. and is repeatedly seasoned and agitated therein.

11. The method of claim 4, wherein in said first seasoning step, the first pottery is stored in a first extraction chamber which maintains 10° C.-38° C. and is repeatedly seasoned and agitated therein, and in said second seasoning step, the second pottery is stored in a second extraction chamber which maintains 10° C.-20° C. and is repeatedly seasoned and agitated therein.
